(19) United States
(12) Patent Application Publication
(10) Pub. No.: US 2021/0222058 A1
(43) Pub. Date: Jul. 22, 2021

(54) SYSTEM, METHOD AND COMPOSITION FOR FRACTURING A SUBTERRANEAN FORMATION

(71) Applicant: Metis Energy LLC, Friendswood, TX (US)

(72) Inventor: Robert Lance Cook, Houston, TX (US)

(73) Assignee: Metis Energy LLC, Friendswood, TX (US)

(21) Appl. No.: 17/225,757

(22) Filed: Apr. 8, 2021

Related U.S. Application Data
(63) Continuation of application No. 16/006,710, filed on Jun. 12, 2018.
(60) Provisional application No. 62/518,349, filed on Jun. 12, 2017.

(51) Int. Cl. C09K 8/80; C09K 8/46; C09K 8/66; C09K 8/72; C09K 8/60; C09K 8/64

(52) U.S. Cl. CPC C09K 8/80; C09K 8/46; C09K 8/665; E21B 43/267; C09K 8/605; C09K 8/64; C09K 8/72

(57) ABSTRACT

A system for fracturing a subterranean formation that includes a supply of a slurry including at least 5% by weight of particles; a pump coupled to the supply of the slurry; a conduit coupled to the pump and extending into the subterranean formation; and a controller operably coupled to the pump for controlling the operation of the pump. The particles have an average equivalent particle diameter of less than 50 microns.

This application claims priority to U.S. provisional patent application 62/518,349, filed Jun. 12, 2017, which is incorporated by reference in its entirety.

### BACKGROUND

This disclosure relates to systems, methods and compositions for fracturing subterranean formations.

Hydraulic fracturing, or fracking, is a process for extracting oil and/or gas from a well. Fracking generally is used to create fractures in a rock formation by injecting the rock with a pressurized liquid. The process involves the high pressure injection of a fracking fluid into a wellbore to create cracks in rock formations through which natural gas and oil will flow more freely. When the hydraulic pressure is removed from the well, grains of hydraulic fracturing proppants can hold the fractures open.

Conventional fracking fluids are mixtures of multiple components designed to deliver proppant to the formation. Common proppants include silica sand, resin-coated sand, bauxite, and man-made ceramics. Viscous fluids, such as gels, are generally used to keep the proppant suspended in the fracking fluid. Such fracking fluids are an expensive component of the fracking process and have drawbacks including the need for high pressure pumping sources and susceptibility to bacterial contamination due to certain additives.

There is a need in the art for alternative fracking systems, methods and compositions that are more economical, require less pumping power, and avoid drawbacks such as susceptibility to bacterial contamination. There is also a need for alternative systems, methods and compositions for propping fractures in a subterranean formation, as well as systems, methods and compositions for fracking and refracking well sites for increasing well production of oil and/or gas products.

### SUMMARY OF THE INVENTION

The present invention is directed to a system for propping fractures in a subterranean formation, comprising a supply of a slurry including at least 5% by weight of particles, a pump coupled to the supply of the slurry, a conduit coupled to the pump and extending into the subterranean formation, and a controller operably coupled to the pump for controlling the operation of the pump, wherein the particles have an average equivalent diameter of 20 to 100 microns. More preferably, the average equivalent diameter of the particles is 30 to 70 microns, and further preferably is about 50 microns. The range of particle equivalent diameters is preferably about sub-1 micron to 200 microns, or sub-1 to 150 microns, or sub-1 to 100 microns, or sub-1 to 50 microns.

In another embodiment, the present invention is directed to a method of propping fractures within a subterranean formation, comprising pumping a slurry including at least 5% by weight of fly ash particles into the fractures within the subterranean formation. Alternatively, the weight % of fly ash in the slurry is at least 10%, at least 15%, at least 20%, at least 25% or at least 30%.

In a further embodiment, the present invention comprises a composition for use in propping fractures within a subterranean formation, comprising water and particles suspended within the slurry's fluid phase having an average equivalent diameter of 20 to 100 microns, 30 to 70 microns, or about 50 microns, wherein the particles comprise at least 5% by weight of the composition. Alternatively, the weight % of particles in the slurry is at least 10%, at least 15%, at least 20%, at least 25% or at least 30%. The range of equivalent diameters of the particles may be sub-1 micron to 200 microns, sub-1 micron to 100 microns, sub-1 microns to 50 microns, or sub-1 microns to 25 microns. In an alternative embodiment the average equivalent diameter of the particles is about 8 microns. In a further preferred embodiment, the particles are fly ash.

In another embodiment of the invention is a composition for use in propping fractures within a subterranean formation, consisting of water and particles of fly ash, wherein the particles mix with the water to create an alkaline carrier fluid for propping fractures within the subterranean formation.

In another embodiment of the invention is a composition for use in propping fractures within a subterranean formation, comprising water and particles of fly ash, wherein the particles mix with the water to create an alkaline carrier fluid for propping fractures within the subterranean formation. The composition preferably contains no polymers, guar or binder materials.

In another embodiment, the invention is directed to a method for mixing and blending fracturing fluids for propping fractures within a subterranean formation, comprising storing proppants, water and other fluids used to slurrify the proppants on the well site, mixing the proppants, water and other fluids in a plurality of batches in accordance with a plurality of slurry specifications, storing the plurality of batches with agitation on the well site; and pumping a slurry comprising at least one of the plurality of batches into the fractures within the subterranean formation at 6 barrels per minute. Alternatively, the pumping is done at a rate of less than about 25 barrels per minute, less than about 20 barrels per minute, less than about 15 barrels per minute, less than about 10 barrels per minute, or less than about 5 barrels per minute.

Another embodiment of the invention is directed to a method of fracking or re-fracking a well site for propping fractures within a subterranean formation of a well site after an initial fracturing operation or set of fracturing operations, comprising storing proppants, water and other fluids used to slurrify the proppants on the well site, mixing the proppants, water and other fluids in a plurality of batches in accordance with a plurality of slurry specifications, storing the plurality of batches with agitation on the well site and pumping a slurry comprising at least one of the plurality of batches into the fractures within the subterranean formation with straddle packers through tubing with a single pump. Preferably the pumping is conducted at a rate of less than about 25 barrels per minute, less than about 20 barrels per minute, less than about 15 barrels per minute, less than about 10 barrels per minute, less than about 5 barrels per minute, or at a rate of about 6 barrels per minute.

### BRIEF DESCRIPTION OF THE DRAWINGS

FIG. 1 is a graphical illustration of the operation of a conventional system for fracturing a subterranean formation.

FIG. 2 is a graphical illustration of the operation of a conventional system for fracturing a subterranean formation.

FIG. 3 is a graphical illustration of the operation of a conventional system for fracturing a subterranean formation.

FIG. 4 is a schematic illustration of an exemplary embodiment of a system for fracturing a subterranean formation.

FIG. 5 is a graphical illustration of the operation of the system for fracturing a subterranean formation of FIG. 4.

FIG. 6 is a graphical illustration comparing the daily average gas MCF for a convention well vs. the same well later fractured according to the invention.

### DETAILED DESCRIPTION

In the drawings and description that follows, like parts are marked throughout the specification and drawings with the same reference numerals, respectively. The drawings are not necessarily to scale. Certain features of the invention may be shown exaggerated in scale or in somewhat schematic form and some details of conventional elements may not be shown in the interest of clarity and conciseness. The present invention is susceptible to embodiments of different forms. Specific embodiments are described in detail and are shown in the drawings, with the understanding that the present disclosure is to be considered an exemplification of the principles of the invention, and is not intended to limit the invention to that illustrated and described herein. It is to be fully recognized that the different teachings of the embodiments discussed below may be employed separately or in any suitable combination to produce desired results. The various characteristics mentioned above, as well as other features and characteristics described in more detail below, will be readily apparent to those skilled in the art upon reading the following detailed description of the embodiments, and by referring to the accompanying drawings.

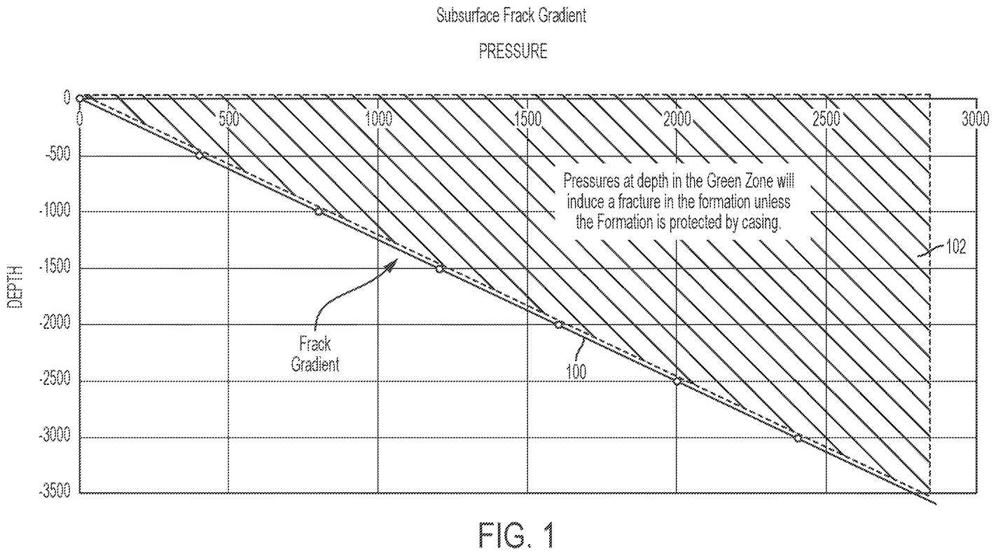

Referring now to FIG. 1, conventional systems for fracturing a subterranean formation traversed by a wellbore exhibit a fracture gradient 100 in which operating pressures above the fracture gradient within a fracture pressure envelope 102 will fracture uncased, perforated, or otherwise exposed or unprotected, sections of the subterranean formation.

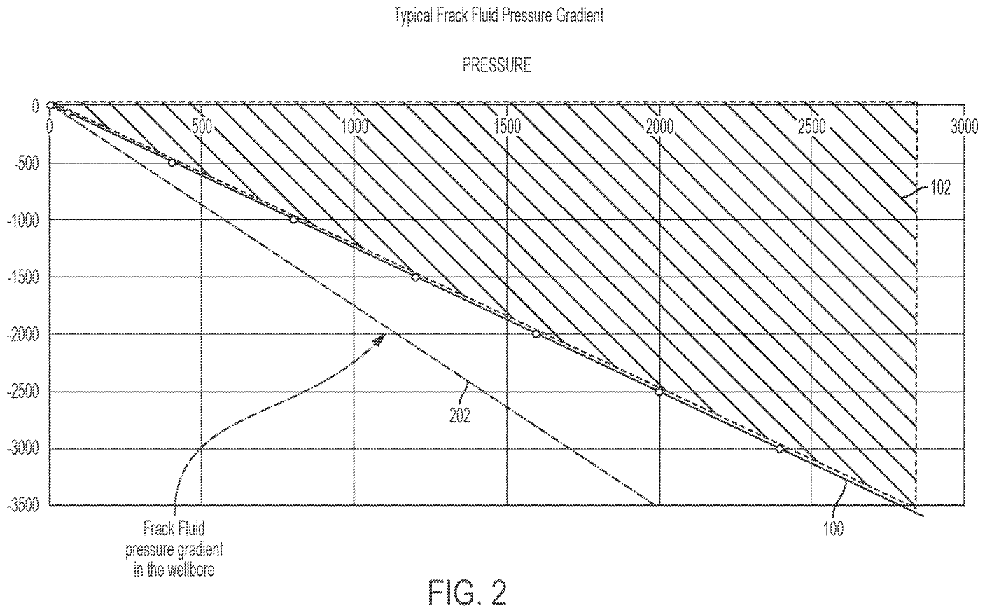

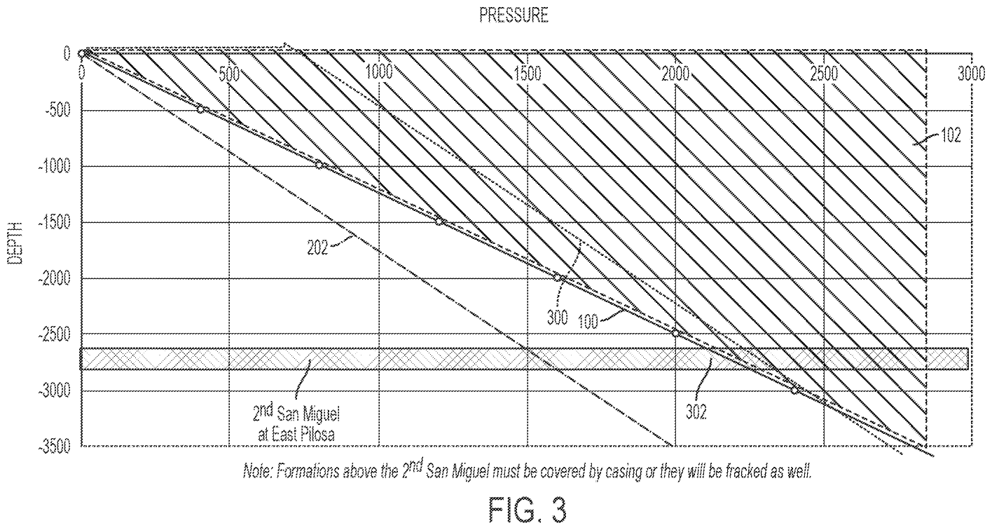

Referring now to FIG. 2, conventional systems for fracturing a subterranean formation further use proppants suspended within a fracking fluid having a pressure gradient 202 that is less than the fracture gradient 100. As a result, as illustrated in FIG. 3, in order to use such conventional fracking fluids, the operating pressure of the fracking fluid must be increased above the fracture gradient using high pressure fracking pumps to a fracking gradient 300 that then lies within the fracture pressure envelope 102. In this manner, an unprotected portion 302 that is exposed to the pressure envelope 102 of a subterranean formation may be fractured.

As used herein, “equivalent diameter” is the same as “equivalent spherical diameter,” or “equivalent particle diameter.” The equivalent diameter of an irregularly shaped object such as a particle is the diameter of a sphere of equivalent volume.

In conventional systems for fracturing a subterranean formation, the equivalent particle diameter of the majority of proppants ranges in size from 100 to 1000 microns.

In conventional systems for fracturing a subterranean formation, the proppants are suspended in the fracking fluid by: a) controlling the fluid velocity which requires a lot of specialized pumps to get high volumetric flow rates ranging from about 0 to 150 barrels per minute, and operating pressures ranging from about 0 psi to 20,000 psi; and/or b) increasing the viscosity of the fracking fluid which results in a gelled frack fluid which requires expensive polymer fluids.

Thus, conventional systems for fracturing a subterranean formation are expensive, complex, and require specialized fracking equipment to mix and pump the larger particle sizes included in conventional proppant slurries and therefore suffer from a number of serious deficiencies.

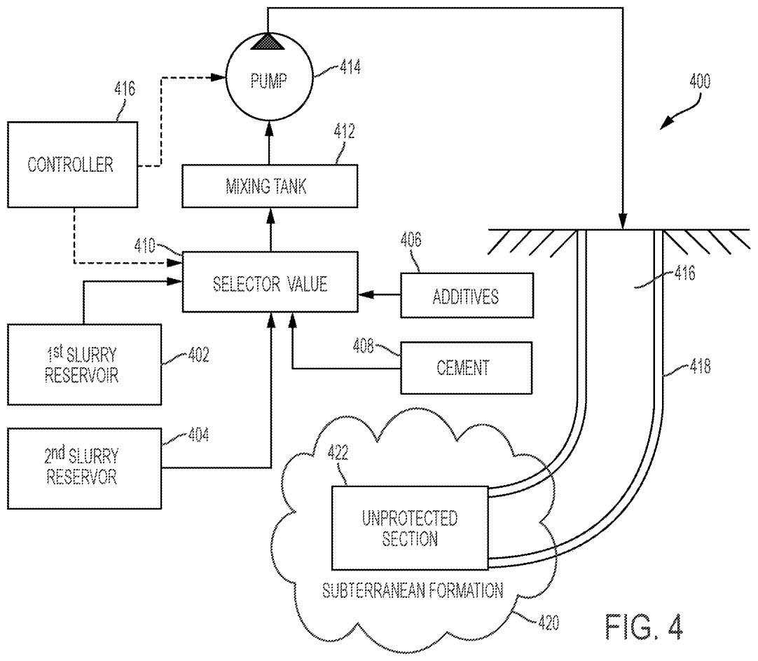

Referring now to FIG. 4, an exemplary embodiment of a system 400 for fracturing a subterranean formation includes a first slurry reservoir 402, a second slurry reservoir 404, a source of additives 406, and a second source for additives such as caustic soda, sodium silicate, binders, etc 408. In an exemplary embodiment, the first slurry reservoir 402, a second slurry reservoir 404, a source of additives 406, and a second source for additives such as caustic soda, sodium silicate, binders, etc 408 are operably coupled to one or more inputs of a selector valve 410.

In an exemplary embodiment, an output of the selector valve 410 is operably coupled to an input of a mixing tank 412 and an output of the mixing tank is operably coupled to the input of a pump 414. In an exemplary embodiment, a controller 416 is operably coupled to the selector valve 410 and pump 414 for controlling the operation of the selector valve and pump.

In an exemplary embodiment, an output of the pump 414 is operably coupled to a passageway 416 defined within a wellbore casing 418. In an exemplary embodiment, the wellbore casing 418 traverses a subterranean formation 420. In an exemplary embodiment, the subterranean formation 420 includes at least portion that is not isolated from internal operating pressures within the casing 418 and is thereby an unprotected portion 422 of the formation. In this manner, in an exemplary embodiment, during operation of the system 400, the subterranean formation may be fractured and the fractures created therein may be propped open using a proppant.

In an exemplary embodiment, the first slurry reservoir 402 includes a slurry of a first proppant suspended in a carrier fluid.

In an exemplary embodiment, the proppants according to the invention comprises particles having equivalent diameters ranging in size from about sub 1 to 200 microns. In another preferred embodiment, the proppants according to the invention comprise particles having equivalent diameters ranging in size from about sub 1 to 150 microns or from about sub 1 to 100 microns or from about sub 1 to 50 microns. In another preferred embodiment, the proppants according to the invention comprises particles having equivalent diameters of less than about 50 microns, less than about 40 microns, less than about 30 microns, less than about 20 microns, or less than about 10 microns. In a further preferred embodiment, the proppants according to the invention comprises particles having an average equivalent diameter of about 8 microns. In another preferred embodiment, the average equivalent diameter of the proppant particles is less than 100 microns, less than 50 microns, less than 40 microns, less than 30 microns, less than 20 microns, less than 10 microns or about 8 microns or less.

In an exemplary embodiment, the particles of the first proppant may include, for example, particles of fly ash, SiO₂ (sand), Al₂O₃ (mainly in bauxite form), or other materials having equivalent crush resistance properties. In an exemplary embodiment, the carrier fluid of the first slurry reservoir 402 may include fresh water, sea water, produced water, diesel, oil, or any other readily available or desirable treatment fluid, or combinations thereof.

In an exemplary embodiment, the second slurry reservoir 404 may include a slurry of a second proppant suspended in a carrier fluid. Like the first proppant, the second proppant preferably comprises particles having equivalent diameters ranging in size from sub 1 to 200 microns. In another preferred embodiment, the proppants according to the invention comprise particles having equivalent diameters ranging in size from 100 to 200 microns, sub 1 to 100 microns or from sub 1 to 50 microns. In another preferred embodiment, the proppants according to the invention comprise particles having equivalent diameters or average equivalent diameters of less than 50 microns, less than 40 microns, less than 30 microns, less than 20 microns, or less than 10 microns. In a further preferred embodiment, the proppants according to the invention comprises particles having equivalent particle diameters of about 8 microns. In another preferred embodiment, the average equivalent particle diameter of the proppant particles is less than 100 microns, less than 50 microns, less than 40 microns, less than 30 microns, less than 20 microns, less than 10 microns or about 8 microns or less.

In an exemplary embodiment, the particles of the second proppant may include, for example, particles of fly ash, SiO₂ (sand), Al₂O₃ (mainly in bauxite form), or other materials having equivalent crush resistance properties. In an exemplary embodiment, the carrier fluid of the second slurry reservoir 404 may include fresh water, sea water, produced water, diesel, oil, or any other readily available or desirable treatment fluid.

The first and second proppants may comprise particles having the same or different ranges of equivalent particles diameters or the same or different average equivalent particle diameters.

More generally, additional slurry reservoirs may be further included, each with a similar or different range of particle sizes, average equivalent particle diameters, and/or particle concentrations.

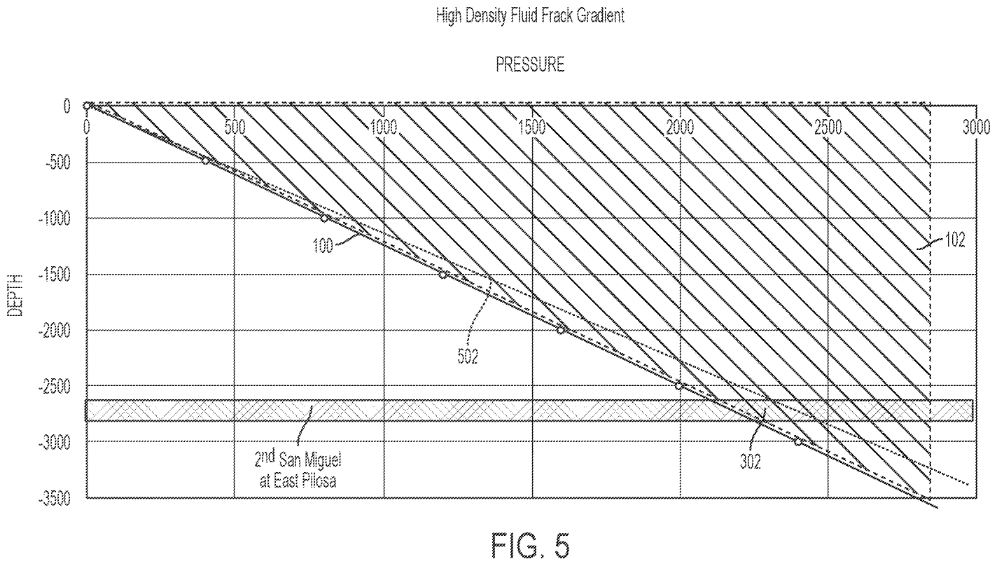

In an exemplary embodiment, as illustrated in FIG. 5, the composition of the slurries provided by the slurry reservoirs, 402 and 404, and any additional such slurry reservoirs, provide a pressure gradient 502 that is greater than the fracture gradient 100. In an exemplary embodiment, the composition of the slurries provided by the slurry reservoirs, 402 and 404, and any additional such slurry reservoirs, provide a weight density ranging from about 5 to about 30 lb/gallon, or about 10 to about 20 lb/gallon or about 8.3 to about 20.0 lb/gallon.

In an exemplary embodiment, the source of additives 406 may, for example, include materials such as low particle sized hematite, barite, or other high density materials. In this manner, the addition of these additives to the slurries provided by the slurry reservoirs, 402 and 404, and any additional such slurry reservoirs, may provide a selected weight density, wherein the weight density is, for example, preferably ranging from about 5 to about 30 lb/gallon, or about 10 to about 20 lb/gallon or about 8.3 to about 20.0 lb/gallon.

In an exemplary embodiment, the source for additives such as caustic soda, sodium silicate, binders, etc 408 may, for example, comprise one or more conventional oilfield cements, other binder materials, caustic soda, sodium silicate that may be combined with the slurries provided by the slurry reservoirs, 402 and 404, and any additional such slurry reservoirs, to thereby enhance the operational efficiency of the proppants therein and, for certain additives, actively create furrows in the frack wall faces to create flow passages for production.

In an exemplary embodiment, the selector valve 410 may comprise one or more conventional selector valves for selecting one or more of the outputs of the first slurry reservoir 402, the second slurry reservoir 404, the source of additives 406, and the source of cement 408 to permit the mixing of such materials within the mixing tank 412.

In an exemplary embodiment, the controller 416 is operably coupled to the selector valve 410 and pump 414 for controlling the operation of the selector valve and pump.

In an exemplary embodiment, during operation of the system 400, the controller 416 operates the selector valve 410 and pump 414 to provide a composition that includes one or more of the outputs from the first slurry reservoir 402, the second slurry reservoir 404, the source of additives 406, and the source of binder 408 to permit the mixing of such materials within the mixing tank 412. The mixed materials are then, by further operation of the pump 414, under the control of the controller 416, injected into the passageway 416 defined within the cased section 418 of the wellbore and into the unprotected portion 422 of the wellbore. Persons having ordinary skill in the art will understand that the unprotected portion 422 of the wellbore may comprise one or more of an uncased section, a perforated section, sliding sleeves, or a screened section of the wellbore.

Continued operation of the pump 414 will thereby fracture the subterranean formation and the proppants injected thereby will prop open fractures in the fractured formation to thereby permit hydrocarbon materials to escape for production.

In an exemplary embodiment, the system 400 for propping fractures in a subterranean formation includes: a supply of a slurry including at least 5% by weight of particles; a pump coupled to the supply of the slurry; a conduit coupled to the pump and extending into the subterranean formation; and a controller operably coupled to the pump for controlling the operation of the pump; wherein the particles have equivalent diameters of less than 50 microns. In an exemplary embodiment, the slurry further comprises: one or more binder materials that may be bonded to the particles. In an exemplary embodiment, the binder materials comprise cement. In an exemplary embodiment, the binder materials comprise phosphoric acid. In an exemplary embodiment, the equivalent particle diameters range from about sub 1 to 200 microns. In an exemplary embodiment, the equivalent diameters of the particles range from about 10 to 100 microns. In an exemplary embodiment, the particles comprise chemically inert particles. In an exemplary embodiment, the slurry consists of water and chemically inert particles. In an exemplary embodiment, the controller is adapted to provide operating pressure of the slurry ranging from about 0 to 15,000 psi. In an exemplary embodiment, the controller is adapted to provide a volumetric flow rate of the slurry that is less than or equal to about 5000 gallons/minute. In an exemplary embodiment, the density of the slurry is greater than a down hole fracture gradient for the subterranean formation. In an exemplary embodiment, the weight density of the slurry ranges from about 8.3 to 15 lb/gallon. In an exemplary embodiment, weight density of the slurry ranges from about 9.0 to 20 lb/gallon.

In an exemplary embodiment, a method of propping fractures within a subterranean formation has been described that includes: pumping a slurry including at least 5% by weight of fly ash particles into the fractures within the subterranean formation. In an exemplary embodiment, the operating pressure of the slurry ranges from about 0 to 15,000 psi. In an exemplary embodiment, the volumetric flow rate of the slurry is less than or equal to about 5000 gallons/minute. In an exemplary embodiment, the slurry further comprises: one or more binder materials that may be bonded to the fly ash particles. In an exemplary embodiment, the binder materials comprise cement. In an exemplary embodiment, the binder materials comprise phosphoric acid. In an exemplary embodiment, the average equivalent diameters of the particles range from sub 1 to 200 microns. In an exemplary embodiment, the equivalent diameters of the particles range from about 10 to 100 microns.

In an exemplary embodiment, the slurry consists of water and fly ash particles. In an exemplary embodiment the slurry contains water, caustic soda, and fly ash particle such that when fracturing operations stop, the fly ash settles to the bottom of the fracture and creates as geopolymer while the high pH carrier fluid etches and furrows the walls of the fractures. In an exemplary embodiment, the density of the slurry is greater than a down hole fracture gradient for the subterranean formation. In an exemplary embodiment, the weight density of the slurry ranges from about 8.3 to 15 lb/gallon. In an exemplary embodiment, the weight density of the slurry ranges from about 9.0 to 20 lb/gallon.

In an exemplary embodiment, a composition for use in propping fractures within a subterranean formation has been described that includes: water and particles suspended within the water having an average equivalent particle diameter of about 8 microns or less; wherein the particles comprise at least 20% by weight of the composition. In an exemplary embodiment, the particles comprise fly ash. In an exemplary embodiment, the particles comprise SiO₂. In an exemplary embodiment, the particles comprise Al₂O₃. In an exemplary embodiment, the particles comprise CaO. In an exemplary embodiment, the composition further comprises one or more binder materials that may be bonded to the particles. In an exemplary embodiment, the binder materials comprise cement. In an exemplary embodiment, the binder materials comprise phosphoric acid. In an exemplary embodiment, the equivalent diameters of the particles range from about sub 1 to 150 microns. In an exemplary embodiment, the equivalent diameters of the particles range from about 10 to 100 microns. In an exemplary embodiment, the particles comprise chemically inert particles. In an exemplary embodiment, the composition consists of water and the inert particles. In an exemplary embodiment, the density of the composition is greater than a down hole fracture gradient for the subterranean formation. In an exemplary embodiment, the weight density of the composition ranges from about 8.3 to 15 lb/gallon. In an exemplary embodiment, the weight density of the slurry ranges from about 9.0 to 20 lb/gallon.

As described previously, the particles of the proppant according to the invention may include, for example, particles of fly ash which is a by-product of coal fired power stations. Depending upon the source and makeup of the coal being burned, components of fly ash may vary considerably. However, almost all fly ash includes calcium oxide (CaO), or quick lime. Generally, fly ash generated by the combustion of coal has less lime and is categorized as Class F fly ash. Fly ash resulting from the combustion of lignite that are rich in lime is categorized as Class C fly ashes. Thus, the amount of CaO varies with different types of fly ash and is a key differentiator between Class C and Class F fly ash. Only between 1.5 to 2.0 grams of quick lime is needed to raise the pH value of a liter of water to 12.4. As a result of the presence of quick lime in a carrier fluid mix, the carrier fluid may become high pH lime water. It has been demonstrated that “significant reaction of the soil minerals and lime was found to occur . . . at elevated temperatures (50-75° C.) in a moist environment.” Wild et al, (1986) Clay Minerals, 21: 279-292. Further, it has been observed that the addition of lime to drilling muds may create a large washout in a drilled shale formation, as the lime chemically reacts with various clays in the shale.

Different carrier fluid designs may demonstrate different etching/furrowing effects on different shale and limestone formations. Currently, fracking is usually done in two different ways: either acid fracking where acids are used to furrow fracture faces, or proppant fracking where a proppant agent is used to prop open the fractures to provide flow paths. Because conventionally propped fractures need guar and polymers to carry the proppant, and acid has a negative impact on guar and polymers, current industry practice rarely combines the two fracking methods in to a single slurry.

In an exemplary aspect, a carrier or fracking fluid composition according to the invention may achieve chemical etching of a subterranean formation exposed during fracturing while propping open segments of fracture walls of the subterranean formation which would otherwise come back in contact with each other to create a flow barrier.

In an exemplary aspect, a carrier fluid formulae with high pH according to the invention may not include polymers or guar to suspend a proppant agent. Specifically, during operation, the resulting alkaline carrier fluid due to the addition of quick lime or caustic soda may furrow a shale formation it contacts, and creates flow paths for produced fluids. Further, the proppant in the fluid, as discussed above with respect to FIGS. 4 and 5, may further hold fractures open between surfaces of the fractures that may not be reactive to the alkaline carrier fluid.

Alternatively, in another exemplary embodiment, an acidic carrier fluid according to the invention may be used to furrow formations instead of or in conjunction with aforementioned alkaline carrier fluid. For example, a pad (fluid not containing any solid) with a 15% hydrochloric acid (HCl) may be used to furrow a limestone, when the alkaline carrier fluid may not. In an exemplary embodiment, the mixing of the alkaline carrier fluid and 15% HCl down hole in micro-fractures may precipitate a CaCl salt on various fracture walls, thereby effectively propping the fractures open.

Moreover, in an exemplary embodiment, quick lime or calcium hydroxide may be added to the carrier fluid mix water to create lime water if pure micro-particles in the range of sub 200 micron sand from a sand mine are used, or if additional and surplus calcium hydroxides are desirable to maintain a high pH in fracture networks down hole. Since CaO (lime) nodules react with water to form Ca(OH)₂, which has 2.5 times the size as unhydrated CaO, adding CaO to the carrier fluid mix right before pumping, small particles may become expanded in size as they hydrate and convert to calcium hydroxide, thereby creating an expandable proppant. Furthermore, as Ca in the lime water carrier fluid react with clays in the subterranean formation, calcium hydroxide particles will be available in the fractures to dissolve and maintain a high pH in the underlying fracture network. As a result, furrowing effect will continue even after the fracking is completed.

Moreover, it is known that conventional frack mixtures may include viscosifiers and diversion agents such as guar and polyacrylamides, which may encourage bacterial growth at different points in a fracturing cycle. As a result, these chemicals are often mixed with a bactericide and pumped down hole. Bacteria growth is problematic at a well site (e.g., dangerous and foul H₂S smell) and it can have long term consequences if bacteria is introduced down hole.

To solve the problem, a fracturing fluid formulae according to the invention may include a slurry of fluids comprising proppants (fly ash) and water without any addition of polymers or a guar or a binder (e.g., cement). As used herein, a binder may be a substance that develops compressive strength and can set and bind other materials together when mixed with water or when an activator is used (such as when caustic soda is added to the water to create a geopolymer when it reacts with the fly ash in a slurry). In an exemplary embodiment, referring to FIG. 4 above, the first proppant in the first slurry reservoir 402 and/or the second proppant in the first slurry reservoir may be mixed with just fresh water and then pumped down hole. As fly ash may be the only addition to the water, lime (CaO) in the fly ash may create lime water in the resulting fracturing fluid with an elevated pH level to, e.g., 12.

It is known that the main function of proppants is to provide and maintain conductive fractures during well production where proppants meet closure stress requirement and show resistance to diagenesis under various down hole conditions. The productivity improvement is mainly determined by the propped dimensions of fractures, which in turn are largely controlled by a settling velocity of the proppant in the fracturing fluid. For example, a high settling velocity may result in the formation of a proppant bank at the bottom of the fracture, while a very low settling velocity may permit the proppant to remain in suspension distributed over a total fracture height. In connection with the descriptions above, the settling velocity of proppants may be controlled by the particle sizes of the proppants without using guar and polymer viscosifiers. Other than the lime, the proppant particles according to the invention are inert in water while the lime will react with the water to ultimately create calcium hydroxides (Ca(OH)₂) which in turn is soluble in water and raises the slurry pH to bacteria hostile levels. As a result, in an exemplary embodiment, a fluid system for fracturing operations may include frack fluids premixed offsite and transported to locations where heavy fracking programs are on-going in a small geographic location. For example, offsite mixing plants may be set up to mix slurries and premixed slurries are transported to a well site for fracking a well with pumps.

Alternatively, in an exemplary embodiment, large volumes of fracturing fluids may be mixed and blended on a well site and the premixed batches may be pumped in between operations on large-scale fracturing operations. Specifically, various fluids used for a fracturing treatment may be transported to a well site. For example, a sufficient amount of proppants may be transported to the well site prior to the fracturing treatment and stored in proppant storage units, often called “proppant silos,” at the well site. However, there may not be enough proppant storage units or space at the well site to store all the proppants for the treatment, and the proppants may be transported by trucks to the treatment site from a nearby proppant distribution center continuously. Water or other fluids used to slurrify the proppants for fracking may be stored in one or more frack tanks at the well site. The materials stored in each frack tank may be connected by a hose or pipeline to a pump for flowing them down a wellbore at a high pressure during the fracturing treatment to push open a subterranean formation and the proppants are used to keep it open. At least one blending tank may be for mixing proppants and other fluids to a desired slurry density.

In an exemplary embodiment, small batches of frack fluids may be mixed based on desired slurry specifications and then stored in large storage tanks with agitation. Each tank may contain similar slurries or slurries with their own distinct properties. Such premixed frack slurries may be subsequently pumped into a wellbore for fracking the well. Due to the small particle sizes of the frack fluid designs of the present disclosure, significantly less horsepower may be needed for fracking a well. For example, in comparison to 60 to 80 bpm for a typical fracking treatment using one cement pump truck, 800,000 lbs of proppants may be pumped at 6 bbls per minute through a regular pump often used in an oil-field, rather than expensive frack pumps, according to the invention.

Generally, a fracking treatment may include fracturing individual zones in a particular well. In some wells there may be one zone to be fracked, while on long horizontal wells, there may be multiple zones (e.g., more than 70 zones) to be fracked.

For multiple zones, the most common practice is “plug and perf.” Specifically, after a first zone is perforated and fracked, a bridge plug attached to a perforating gun may be pumped down the well to a predetermined depth. The perforating gun is then fired to perforate the casing or liner and removed from the well. The first zone is then fracked. This process may be repeated a number of times until all zones have been fracked. The bridge plugs are then drilled out and the well put on production after the frack spread (crews and equipment needed to perform a fracking treatment) leaves location.

During the running of the plug and perforating gun, large batches of frack fluids may be mixed according to the invention at least during the time a wireline run is being made to lower the perforating gun into the casing. Once the wireline run is finished, premixed slurry may be pumped to frack the well while mixing of additional slurries continues. As a result, a single experienced crew may be required to run only daylight operations for pumping while batch mixing of frack fluids at night may be performed by a third party labor.

Further, for a typical fracking treatment, one frack spread arrangement may include three distinct crews: two crews alternate on a 12-hour shift, and one on their days off. Each crew often works 8 days and has 4 days off, and they are required to have extensive training. It is not unusual for a frack crew to have over 80 staff split among the three crews.

In an exemplary embodiment, the frack fluid mixing and blending process on a well site according to the invention may initially require just one small crew (e.g., one trained crew of around 6-8 full-time staff) to perform pumping during daylight hours while other crews at night mix large batches of frack slurries to be pumped the following day. As such, rather than maintaining a full frack spread, only minimal equipment may be required initially for a fracking operation according to the invention resulting in low depreciation of the equipment, less repair and maintenance costs. As business demand increases, a night crew may be added to execute pumping services 24 hours a day. Even smaller crews may be practical in locations where experienced roustabout crews are available to support the frack fluid mixing and blending operations.

As discussed above, according to exemplary embodiments of the present disclosure, significantly less horsepower and slower pump rates may be needed for fracking a well. For example, proppants may be pumped at 6 bbls per minute according to the invention rather than 60 to 80 bpm inside casing for a typical fracking treatment. In an exemplary embodiment, a system according to the invention may be used for refracturing tens of thousands of unconventional wells (e.g., shales with long laterals requiring multiple frac stages) that are already producing. Re-fracking is the practice of returning to older shale oil and gas wells that had been fracked in the recent past to capitalize on newer, more effective extraction technology. Re-fracking may be effective on especially tight deposits (e.g., where the shale or sand produces low yields) to expand their productivity and extend their life. Re-fracking technology has been slow to develop because the cost is usually higher than an original fracture stimulation due to the need to isolate individual perforations while maintaining the ability to pump at high rates and pressures. For example, in an oil field application, a conventional straddle assembly generally may have two packers connected to each other in a well in a manner that isolates a section between both two packers from zones above and below the assembly. Such packers may be placed in the well along with a liner at locations to provide isolation for each frac stage from old perforation up-holes. However, most old wells may not be recompleted and fractured due to their associated low pressure casing and wellheads and different pad sizes that are used with a conventional straddle system. For example, pumping frack fluids at high rates (e.g., 60 to 80 bpm for a typical fracking treatment) would not be feasible through tubing at any practical pressure for such old wells during a re-fracking operation.

In an exemplary embodiment, a re-fracking system according to the invention may control the pump rates of proppants and frack fluids using conventional straddle packers through tubing with a single pump, thereby simplifying re-fracking operations and reducing costs. Such a re-fracking system may be used to, for example, enable recompletions and fracturing of an oil or gas well that is nearing the end of its economically useful life. The assumption challenged and proven erroneous is that the permeability in a bed of a proponent must have a permeability higher than the rock matrix being fractured in order for the wells productivity to be significantly improved. The unexpected effect of the invention is that the effective permeability in a fracture is a complex function of very high permeability ullages created by the proppant that holds open the fracture and through high permeability interfaces between the proppant bed and the rock matrix. To prove that productivity in a fracture network would be governed more by the ullages and high permeability interfaces than it would be through relatively high permeability in fracture proppant bed, a 400,000 pound fracture was performed on a wellbore as detailed in Example 1.

### Example 1

A field trial was conducted with a fracking fluid prepared by suspending 400,000 pounds of 325 mesh proppant in only water and pumping it at a rate between 6 and 8 bbls per minute with a single dual pump 1150 HHP cementing unit. The proppant had an average particle size of less than 60 microns. This dramatic decrease in the horsepower required and the lack of additives to the carrier fluid resulted in a cost to perform the fracture under half what a normal fracture of this size would have cost.

Current theory predicts little to no improvement would be seen by having such a low permeability proppant pack for the production of oil and water, yet productivity after the frack was improved by over 500%.

The significance of this proof of concept is that very fine particles can be used to frack wells with benefits far beyond what has recently been recognized as the benefit of adding small particles to a fracture operation to improve the distance the small particles are carried from the wellbore into the fracture network and because of the small particles' ability to penetrate and prop open small fractures that current proppant commonly used cannot enter. The unique enabling capability created by proving that fracture proppant pack permeability contrasts do not need to be high in order to significantly improve productivity derives from the fact that if fractures are designed mainly around particle sizes 200 microns and below, fracturing operations can be performed using only sub 1 micron to 200 micron proppant in a carrier fluid with no carrying agent such a polymers or guar and their required associated additives (eg. biocides).

The small particles can give good productivity improvement results despite having low fracture proppant pack to formation matrix permeability contrast, a wide range of cost saving and productivity improving design opportunities are created.

This example demonstrates that if you are no longer designing a fracture to obtain a high permeability proppant pack, a high density slurry can be designed such that the hydrostatic head of the slurry column itself can be used to frack the well and that the slow settling of the small size proppant can mean that low flow rates during the frack can be used with minimal risk of particles bridging off in the wellbore or formation. Common oilfield cementing practices where sub 325 mesh cement particles are suspended in water requiring no suspension agents like guar or polymers with minimal risk of bridging during operations and the successful high loading of proppant in to a slurry of over 15 ppg in over a 1000 barrels of water during the field trial.

Small particle size barite or hematite could be added to the proppant slurry in order to get densities of 20 ppg or greater, as is done in certain cases for cementing operations. The implications here are wide ranging as it enables remote location fracking to be done using only locally available equipment because most of the energy used to create the fractures in the formation is simply the hydrostatic head. Thus, in an extreme case, a well could be fractured with little or no surface horsepower. This surprising result means that rather than the massive fracturing spreads currently viewed as required to fracture wells becomes optional as fracturing can now be designed and done with minimal surface equipment. While current frack spreads may be desirable for many operations where fracking infrastructure already exists, this finding means in remote locations, where the cost of bringing in a large frack spread to frack a single exploratory well, fracturing can now be done at a cost literally an order of magnitude cheaper than is currently possible due to the high cost to import fracking equipment for a single job to the remote site.

Further benefits include the fact that without the need for polymers, guar, and other carrying agents, which require specifically designed carrier fluids where the polymers and guar swell and expand, fracking can be conducted using most any fluid as a carrying agent.

In this example, the frack slurry's pH was raised to 12.4 from the CaO contained in the fly ash used. Subsequent lab experiments have been done to develop a frack slurry that can both create furrows through chemical reactions with the fracture facies similar to what is done with an acid frack, while still carrying a full load of proppant to prop open formations which may not be chemically reactive. One such lab test added caustic soda to a proppant slurry to obtain a pH of 14.0. Shale samples were placed in the slurry for 24 hours at elevated temperature and a 10% weight loss was recorded, as compared to no weight loss or slight weight gains (gains were small enough to possibly simply be random measurement errors) for control samples with no caustic soda added. Further, by mixing lye with and aluminum rich fly ash, the fly ash will bind together to create a geopolymer which will not allow the proppant to flow back in to the well bore during the productions phase. Simply put, the elimination of the requirement for carrying agents for large particles opens up the use of a wide range of chemicals which may be desirable for fracking operations but which would otherwise not be compatible with currently used carrier fluids, polymers, guar, etc.

Through the use of sub 200 micron particle sizes, a wide range of potential proppant material is opened up. For example, most sand mined for proppant is screened to various sizes for different frack designs. Little of the sand that passes through a 140 mesh screen is sellable today as a proppant. This finding opens up the use of what in some cases might be considered a waste product for use.

Similarly a large portion of kiln dust, blast furnace slag, fly ash, cement silo bottoms, etc, from various manufacturing operations end up in landfills. The findings explained in this filing opens up a huge potential beneficial use for what is currently often a waste by product destined for landfills. The finding disclosed herein is surprising and can fundamentally change fracturing design practices while substantially reducing the surface footprint current fracturing practices require, while the opportunity to use mainly waste by products for fracturing such as produced formatation water and kiln dust and/or fly ash destined for landfills.

### Example 2

A field trial was performed in an Olmos Gas sand in Texas. The well was at least 12 years old and had 4.5″ casing. The well was fracked with 1196 bbls of slurry which included 3000 cubic feet of fly ash and the balance produced water from the field. The only other additive was a defoamer to reduce the foam created by the produced water, which contains soap from the use of soap sticks to unload wells.

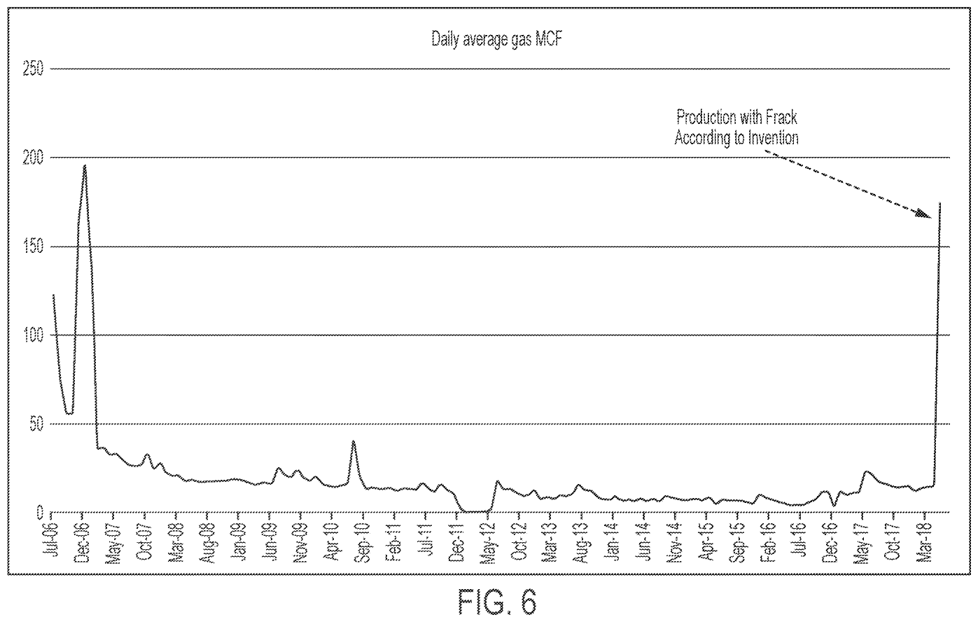

The results demonstrated that the materials and methods according to the invention can both reduce fracking cost while delivering productivity results superior to current fracking techniques. While the frack cost was a little under 69,000 USD and only used one cementing unit to execute, the well performed at rates similar to or better than its performance after it was originally completed in 2006. See FIG. 6.

It is understood that variations may be made in the above without departing from the scope of the invention. While specific embodiments have been shown and described, modifications can be made by one skilled in the art without departing from the spirit or teaching of this invention. The embodiments as described are exemplary only and are not limiting. Many variations and modifications are possible and are within the scope of the invention. Furthermore, one or more elements of the exemplary embodiments may be omitted, combined with, or substituted for, in whole or in part, one or more elements of one or more of the other exemplary embodiments. Accordingly, the scope of protection is not limited to the embodiments described, but is only limited by the claims that follow, the scope of which shall include all equivalents of the subject matter of the claims.

1. A system for propping fractures in a subterranean formation, comprising:
a supply of a slurry including at least 5% by weight of particles;
a pump coupled to the supply of the slurry;
a conduit coupled to the pump and extending into the subterranean formation; and a controller operably coupled to the pump for controlling the operation of the pump;
wherein the particles have an average equivalent diameter of 25 to 100 microns.

2. The system of claim 1, wherein the slurry further comprises:
one or more binder materials that may be bonded to the particles.

3. The system of claim 2, wherein the binder materials comprise cement.

4. The system of claim 2, wherein the binder materials comprise phosphoric acid.

5. The system of claim 1, wherein the equivalent diameter of the particles ranges from sub 1 to 200 microns.

6. The system of claim 1, wherein the equivalent diameter of the particles ranges from about 10 to 200 microns.

7. The system of claim 1, wherein the average equivalent diameter of the particles is less than 50 microns.

8. The system of claim 1, wherein the slurry consists of water and inert particles.

9. The system of claim 1, wherein the controller is adapted to provide operating pressure of the slurry ranging from about 0 to 15,000 psi.

10. The system of claim 1, wherein the controller is adapted to provide a volumetric flow rate of the slurry that is less than or equal to about 5000 gallons/minute.

11. The system of claim 1, wherein the density of the slurry is greater than a down hole fracture gradient for the subterranean formation.

12. The system of claim 1, wherein the weight density of the slurry ranges from about 5 to 30 lb/gallon.

13. The system of claim 12, wherein the weight density of the slurry ranges from about 10 to 20 lb/gallon.

14. The system of claim 1, wherein the slurry fluid phase comprises fresh water, sea water, produced water, diesel, oil, treatment fluid, or a combination thereof.

15. A method of propping fractures within a subterranean formation, comprising:
pumping a slurry including at least 5% by weight of fly ash particles into the fractures within the subterranean formation.

16. The method of claim 15, wherein the operating pressure of the slurry ranges from about 0 to 15,000 psi.

17. The method of claim 15, wherein the volumetric flow rate of the slurry is less than or equal to about 5000 gallons/minute.

18. The method of claim 15, the slurry further comprises:
one or more binder materials that may be bonded to the fly ash particles.

19. The method of claim 18, wherein the binder materials comprise cement.

20. The method of claim 18, wherein the binder materials comprise phosphoric acid.

21. The method of claim 15, wherein the equivalent diameters of the particles ranges from about 1 to 200 microns.

22. The method of claim 15, wherein the equivalent diameters of the particles ranges from about 10 to 200 microns.

23. The method of claim 15, wherein the slurry consists of water and fly ash particles.

24. The method in claim 15 wherein the slurry consists of water, fly ash particles, and caustic soda.

25. The method of claim 15, wherein the density of the slurry is greater than a down hole fracture gradient for the subterranean formation.

26. The method of claim 15, wherein a weight density of the slurry ranges from about 5 to 30 lb/gallon.

27. The method of claim 15, wherein the weight density of the slurry ranges from about 10 to 20 lb/gallon.

28. A composition for use in propping fractures within a subterranean formation, comprising: water and particles comprising fly ash, wherein the particles mix with the water to create an alkaline carrier fluid for propping fractures within the subterranean formation.

29. The composition of claim 28, wherein the composition comprises no polymers, or a guar, or a binder.

30. The composition of claim 28, further comprising a pad with a 15% hydrochloric acid (HCl).

31. The composition of claim 28, further comprising calcium oxide and calcium hydroxide particles.

32. The composition of claim 28, wherein the composition comprises no bactericide.

33. A method of fracking or re-fracking a well site for propping fractures within a subterranean formation of a well site, comprising:
storing proppants, water and other fluids used to slurrify the proppants on the well site;
mixing the proppants, water and other fluids in a plurality of batches in accordance with a plurality of slurry specifications, respectively;
storing the plurality of batches with agitation on the well site; and
pumping a slurry comprising at least one of the plurality of batches into the fractures within the subterranean formation at a rate of under 20 barrels per minute using straddle packers through tubing with a single pump.

34. The method of claim 33, wherein the rate of pumping is less than 10 barrels per minute.

35. The method of claim 33, wherein the rate of pumping is about 6 barrels per minute.
